(19) United States
(12) Patent Application Publication
(10) Pub. No.: US 2009/0008966 A1
(43) Pub. Date: Jan. 8, 2009

(54) Moulded Plastic Article and a Method for the Production Thereof

(75) Inventors: Franz Hebauer, Regensburg (DE); Jan Wokoeck, Bad Aibling (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WEBASTO AG, Stockdorf (DE)

(21) Appl. No.: 11/720,447

(22) PCT Filed: Nov. 22, 2005
(86) PCT No.: PCT/DE05/02097

§ 371 Date: Jun. 2, 2008

(30) Foreign Application Priority Data
Nov. 30, 2004 (DE) 10 2004 057 810.9

(51) Int. Cl. B60J 7/02; B29C 45/14

(52) U.S. Cl. 296/214; 264/266

(57) ABSTRACT

A molded plastic article has an injected or foamed molded section (12) with at least one insert part (24) with a part (16A-16D) which emerges from the molded section (12). The insert part (24) penetrates a deformable molded body (34) which forms a sealing element for the mold cavity when the injected or foamed molded section (12) is produced in the mold cavity of a molding tool. A process for producing the molded plastic article involves locating the molded body (34, 46) together with the insert part in the region of an edge of the mold cavity, closing the tool unit so that the molded body undergoes deformation and the mold cavity in the region of the emergence of the insert part from the mold cavity is sealed by the molded body.

### BACKGROUND OF THE INVENTION

1. Field of Invention

The invention relates to a molded plastic article having an injected or foamed molded section with at least one insert part which emerges from the molded section and a process for producing such a molded plastic article.

2. Description of Related Art

Molded plastic articles which are produced according to an injection or foaming process can be used in diverse forms. In the area of automotive engineering molded articles are used, for example, as a sliding headliner of a vehicle roof or also as a peripheral plastic frame of a glass cover element of a sliding roof.

Often, it is necessary for a molded plastic article to be provided with insert parts which are embedded in the foamed or injected molded section of the molded plastic article and which emerge from it. For example, in a foamed sliding headliner they form sliding elements for guiding the sliding headliner in a rail system or, for a sliding roof, brackets for joining a cover element to the vehicle body.

In the production of a molded plastic article which comprises a molded section which is made in the mold cavity of a molding tool, and which is provided with an insert part which emerges from the molded section, it is necessary to seal the mold cavity to form the molded section so that upon injection or foaming of the molded section the material used for producing the molded section does not emerge from the mold cavity. This seal can be a problem in the region of emergence of the insert part from the molded section.

In the past, the mold cavity in the region of the insert part was sealed by means of a plastic sealing profile which is assigned to one tool half of the molding tool which forms the mold cavity with the second tool half. Sealing takes place here in the plane of separation between the two tool halves.

However, the disadvantage is that the sealing profile must be regularly changed; this caused machine downtime. The tool used to produce the molded plastic article can therefore only be operated with an increased cycle time. Furthermore, the cost-intensive sealing profile is subject to wear; this in turn leads to high tolerances. Thus, there is also a certain fluctuation in the quality of the sealing of the sealing profile.

Furthermore, sealing can also take place via after-sealing by pressing together the two tool halves which are provided with fitting surfaces. The sealing of the mold cavity via fitting surfaces, however, only allows very small tolerances. This can lead, in turn, to problems with tool engineering.

### SUMMARY OF THE INVENTION

The object of the invention is to devise a molded plastic article and a process for producing a molded plastic article in which the aforementioned problems do not occur.

This object is achieved in accordance with the invention by a molded plastic article in which at least one insert part emerges from the molded section penetrates a deformable molded body which, when the molded section is produced in the mold cavity of a molding tool, forms a sealing element for the mold cavity. The object is also achieved by a method in accordance with the invention in which the molded body together with the insert part is located in the region of an edge of the mold cavity, the tool unit closed so that the molded body undergoes deformation and the mold cavity in the region of the emergence of the insert part from the mold cavity is sealed by the molded body, then a material for forming the molded section placed in the mold cavity so that it is connected to the insert part and the molded body

Therefore, the subject matter of the invention is a molded plastic article in which a sealing element which is used in production of the molded section and which is formed by the molded body is an integrated component. By using such a sealing element, reliable and economical sealing in the region of the emergence of the insert part from the mold cavity can be produced for forming the molded section. Costly precautions on the molding tool for sealing the mold cavity in the exit region of the insert part need not be taken. The molded body can be shaped such that its visible surfaces are essentially flush with the bordering visible surfaces of the molded section. This, in turn, leads to a pleasant appearance.

The plastic molded article which is made as an injection molding or foamed article in accordance with the invention can be made in diverse shapes and for example constitutes the sliding headliner of a vehicle roof, then the molded section forming a flat darkening element of the sliding headliner and the insert part preferably forming a sliding element for guiding the sliding headliner on the rail arrangement. But, it is also conceivable for the molded plastic article to be a plastic frame which has been foamed onto a glass cover element of a sliding vehicle roof and in which insert parts for joining the cover element to the vehicle body are foamed. The molded plastic article therefore represents only one part of the final product.

The molded body can be used not only for sealing of the mold cavity, but can also assume functional tasks. For example, the molded body itself can form a sliding block for a movable component.

In order to ensure reliable sealing in the region of the emergence of the insert part from the mold cavity to form the molded section, it is advantageous if the molded body is located in the region of the plane of separation of the molding tool and preferably has essentially opposing action surfaces for the molding tool. The molding tool acts on the action surfaces when closing so that the molded body is deformed as a result of the acting pressure; this in turn ensures the tightness of the mold cavity for producing the molded section based on the resulting surface pressure.

The molded body which is penetrated by the insert part is an injection molding in one preferred embodiment of the plastic molded article in accordance with the invention. It can be either directly injected on the insert part or however only after its production can be joined to the insert part. The insert part can also be formed by a section of a plastic profile or other plastic article.

When the molded body is connected to the insert part only after its production, it can be advantageous for it to be formed of two parts which are connected to one another via a connecting means, for example, a grid means.

To ensure sufficient tightness in the region of the transition between the insert part and the molded body, in subsequent attachment of the molded body to the insert part it is advantageous if the molded body has a recess for passage of the insert part which is produced with a dimension smaller than specified. This ensures that with the molding tool closed, high contact pressures between the insert part and the molded body result.

The molded body which constitutes a sealing element can be formed from a material which forms a nonpositive connection to the molded section when the latter is formed and crosslinks with it. But, it can also be provided that the molded section and the molded body are produced from materials which do not adhere. This is, for example, the case when the molded body is formed of polypropylene and the molded section is formed from a polyurethane foam. In this case, it is advantageous if the molded body has anchor means for the material of the molded section. The anchor means comprise, for example, holes which are made in the molded body and into which the material of the molded section penetrates, or also undercuts so that the molded body is undercut in regions by the injected or foamed molded section.

In order to achieve reliable sealing of the mold cavity to form the molded section in all regions of the molded body, it is advantageous if the molded body has sides which run outwardly in the shape of a wedge. This ensures that the molding tool which is used builds up a relatively high contact pressure on the entire periphery of the molded body. Surfaces which are aligned essentially parallel to the closing direction of the molding tool used could lead to tightness problems in injection or foaming of the molded section.

Preferably, the molded body is made plastically deformable so that after removal from the molding tool it retains its shape. Alternatively, however, it is also conceivable to use an elastically deformable material for the molded body which again assumes its initial shape after its removal from the molding tool which is used to form the molded section.

The subject matter of the invention furthermore is a process for producing a plastic molded article which comprises a molded section and at least one insert part in a molding tool. The molding tool comprises an openable tool unit which forms a mold cavity. In accordance with the invention, in the process, the insert part is provided with a deformable molded body such that the insert part penetrates the molded body, the molded body together with the insert part is located in the region of one edge of the mold cavity, the tool unit is closed so that the molded body undergoes deformation and the mold cavity in the region of the emergence of the insert part from the mold cavity is sealed by the molded body, and then a material for forming the molded section is placed in the mold cavity so that it is connected to the insert part and the molded body.

By using this process the mold cavity in the region of emergence of the insert part can be reliably sealed. The tool unit must of course be provided with a correspondingly made receiving region for the molded body.

The seal in the region of the molded body can be further enhanced if the tool unit in the region of the molded body is provided with a pinch edge which engages the molded body when the tool unit is closed. Alternatively or additionally, the molded body can also be provided with a fin or the like which engages a groove of the tool unit.

Other advantages and advantageous configurations of the subject matter in accordance with the invention will be apparent from the detailed description below in conjunction with the accompanying drawings which show an embodiment of a plastic molded article in accordance with the invention and a process designed in accordance with the invention for producing such a plastic molded article.

### BRIEF DESCRIPTION OF THE DRAWINGS

FIG. 1 shows a top view of the sliding headliner of a vehicle roof;

FIG. 2 shows the region of the sliding headliner which encompasses the sliding element and a sealing element;

FIG. 3 shows a perspective top view of the sliding element and the sealing element in isolation;

FIG. 4 shows a top view of the sliding element and the sealing element;

FIG. 5 shows a side view of the sliding element and the sealing element;

FIG. 6 shows the arrangement of the sealing element in a molding tool; and

FIG. 7 shows a schematic front view of one alternative embodiment of a sealing element.

### DETAILED DESCRIPTION OF THE INVENTION

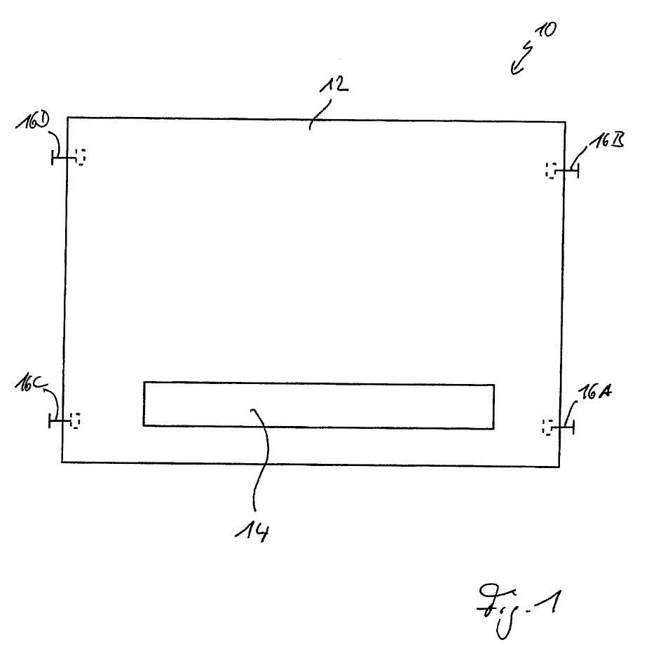

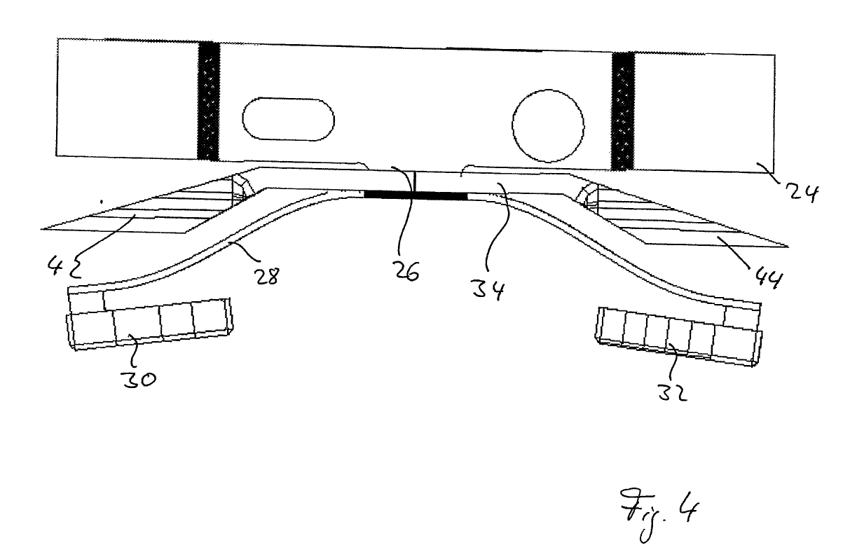

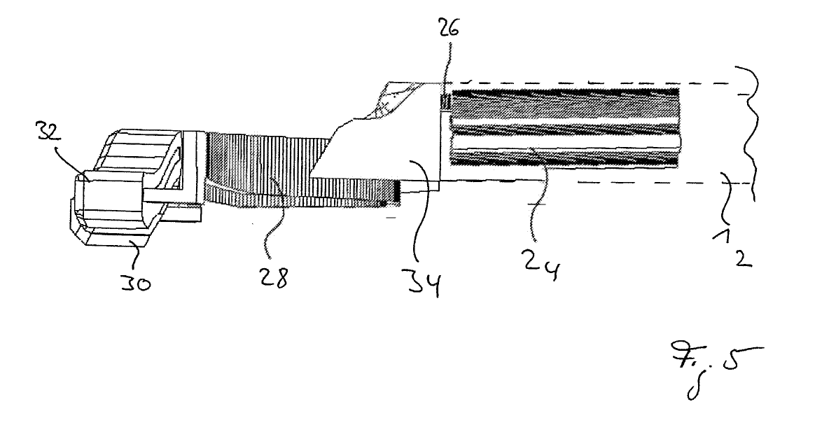

FIGS. 1 to 6 schematically show a sliding headliner 10 of a motor vehicle roof, the details of which are not otherwise shown, and which is used to darken a roof opening which can be closed by means of a glass cover. The sliding headliner 10 constitutes a molded plastic article which comprises a flat molded section 12 which constitutes a darkening element and which is formed from polyurethane foam, with a ventilation cutout 14 and four sliding elements 16A, 16B, 16C, 16D which are located in pairs on each side of the molded section 12 and which are used to guide the sliding headliner 10 in a roof-mounted rail arrangement which is assigned to the sliding roof. The sliding elements 16A to 16D are each made as an insert part which is foamed into the molded section 12 which is made of polyurethane.

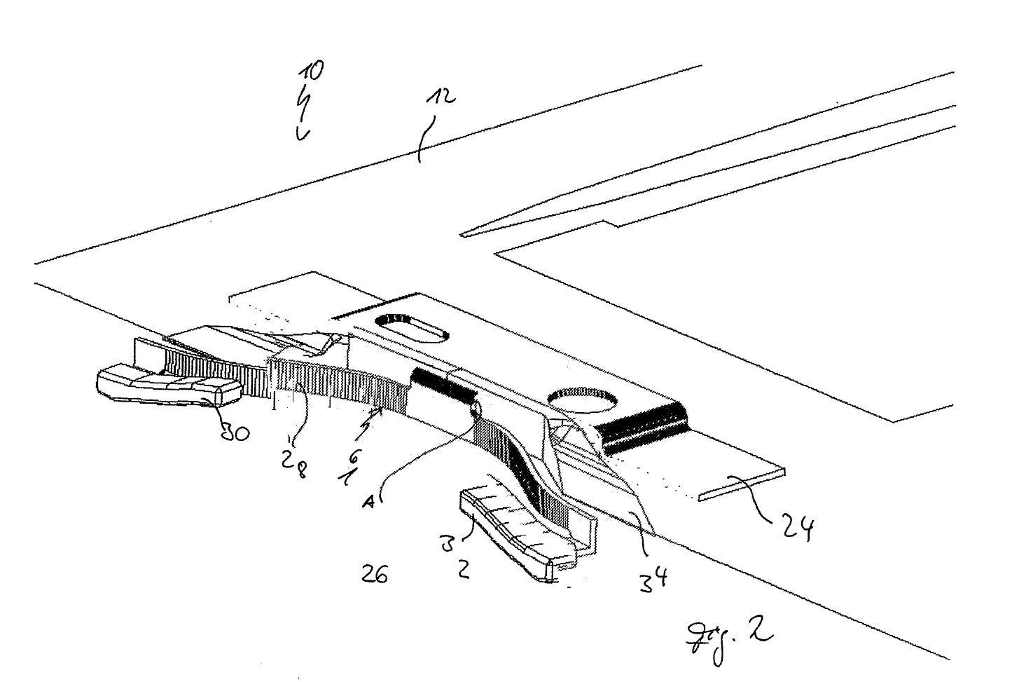

As can be taken especially from FIGS. 2 to 5, the sliding elements 16A to 16D each comprise a foamed section 24 which is made essentially plate-like and which is embedded in the molded section 12. The foamed section 24 is connected via a connecting section 26 to a leaf spring-like sliding spring 28 which is provided with two sliding blocks 30, 32.

The connecting section 26 of the sliding element penetrates a molded body 34 which is an integrated component of the sliding headliner 10 and is injected before foaming of the molded section 12 on the sliding element 16A, 16B, 16C, 16D which constitutes the insert part. The molded body 34 is made of polypropylene and forms a plastically deformable component.

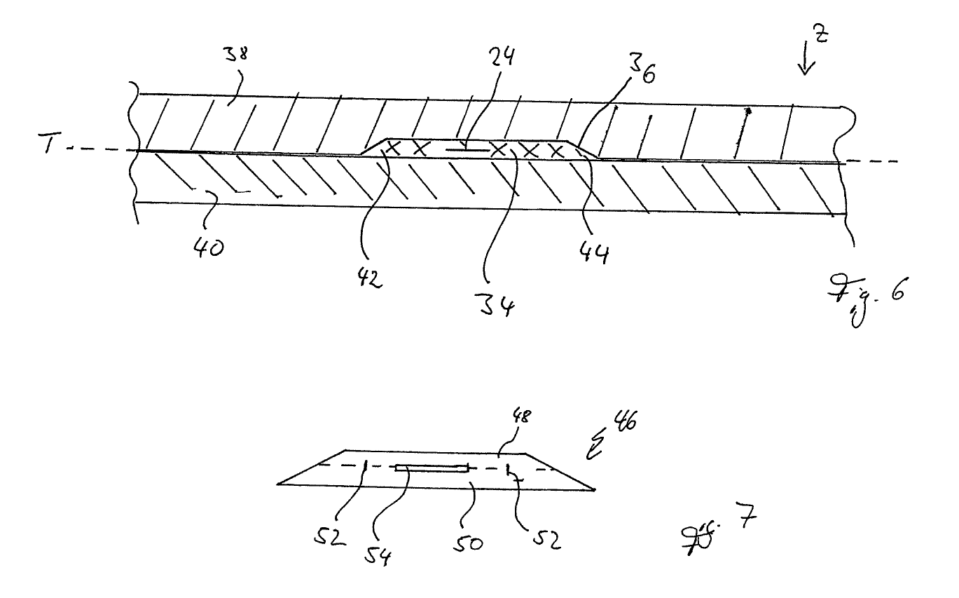

In the production of the molded section 12 in a foaming tool, the molded body 34, as shown in FIG. 6, is located in a corresponding recess 36 of the tool unit of a molding tool which comprises an upper tool 38 and a lower tool 40, the molded body 34 with the tool unit closed, i.e., when the upper tool 38 has been moved to the lower tool 40, being compressed in the direction indicated in FIG. 6 by Z, by which reliable sealing of the mold cavity, which is otherwise not shown here, takes place for forming a flat darkening element or molded section 12. To achieve a reliable sealing action over the entire periphery of the molded body 34, the molded body 34 has sides 42, 44 which run outwardly in the shape of a wedge so that it is ensured that the molded body 34 positively adjoins the upper tool 38 and the lower tool 40 on all sides with a high sealing action. The molded body 34 is located in the region of the plane of separation T of the tool unit formed from the upper tool 38 and the lower tool 40, which plane is shown crosshatched in FIG. 6.

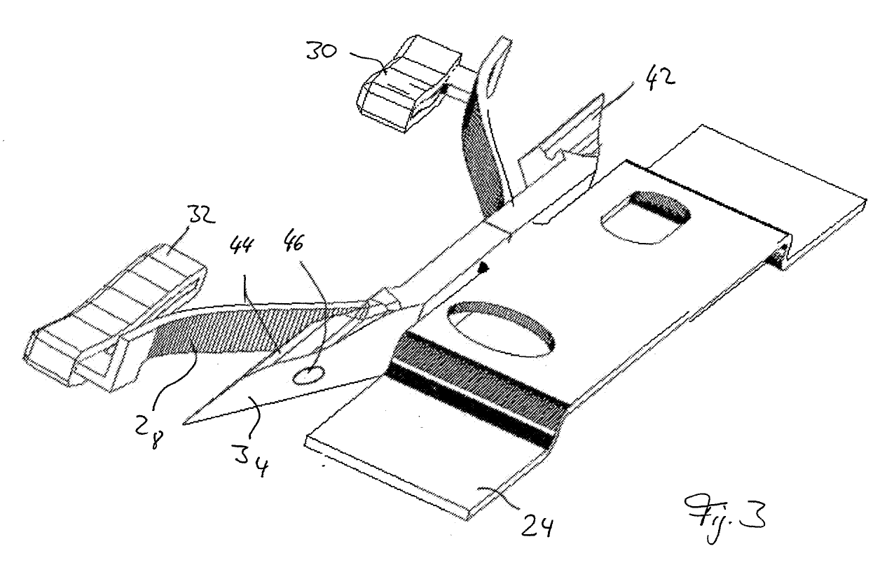

As can be taken from FIG. 3, the molded body 34 in the region of each of the ends 42, 44, on the side facing the molded section 12, is provided with a respective hole 46 which constitutes the anchor means for the polyurethane material of the darkening element or molded section 12. Therefore, the holes 46 ensure a nonpositive connection between the molded body 34 and the molded section 12 by the penetration of the not yet hardened polyurethane material.

Each of the upper tool 38 and the lower tool 40 can be provided in the region of the molded body 34 with a pinch edge (not shown here) which engages the molded body 34 to increase the sealing action with the tool unit closed. Alternatively, the molded body 34 can also be provided peripherally with a fin, bead or the like which engages the grooves of the upper tool 38 and of the lower tool 40.

In the production of the sliding headliner 10 in the molding tool, first of all, a respective molded body 34 is molded onto the connection regions 26 of the sliding elements 16A, 16B, 16C, and 16D, so that a positive and tight connection between the respective molded body 34 and the respective sliding element 16A, 16B, 16C, and 16D, which constitutes the insert part, is produced and the respective insert part penetrates the pertinent molded body 34. Then, the molded body 34 together with the pertinent insert part 16A, 16B, 16C, 16D is located in the region of an edge of a mold cavity for forming the flat molded section 12. Then, the tool unit which is formed from the upper tool 38 and the lower tool 40 is closed so that the molded body 34 is pinched at a right angle to the plane of separation T and undergoes deformation and the mold cavity in the region of the emergence of the pertinent insert part 16A, 16B, 16C, and 16D from the mold cavity is sealed by the respective molded body 34. Then, a polyurethane foam is delivered into the mold cavity for forming the molded section 12 so that it is connected to the insert parts 16A to 16D and the respectively assigned molded body 34.

FIG. 7 shows an alternative embodiment of a molded body 46. The molded body 46 differs from the molded body shown in FIGS. 2 to 6 in that it is formed from two parts 48, 50 which only after their production according to an injection process are connected to one another via catch connections 52 so that the pertinent insert part penetrates the recess 54 of the molded body 46. In order to achieve a high level of tightness in the transition region between the molded body 46 and the insert part which penetrates the recess 54, the recess 54 is provided with a dimension smaller than specified for the dimensions of the insert part in its connection section 26 between the foamed section 24 and the sliding spring 28.

1-12. (canceled)

13. Molded plastic article, comprising
an injected or foamed molded section,
at least one insert part a portion of which emerges from the molded section, and
a deformable molded body;
wherein the insert part extends into the molded section through the deformable molded body, the deformable molded body, when the molded section was produced in a mold cavity of a molding tool, formed a sealing element for the mold cavity.

14. Molded plastic article as claimed in claim 13, wherein the molded body is joined to the insert part by having been injected onto the insert part.

15. Molded plastic article as claimed in claim 13, wherein the molded body is formed of two parts which are connected to one another via a connection means.

16. Molded plastic article as claimed in claim 13, wherein the molded body has anchor means for securing the molded body in the material of the molded section.

17. Molded plastic article as claimed in claim 13, wherein the molded body has ends which run outwardly in the shape of a wedge.

18. Molded plastic article as claimed in claim 13, wherein the molded body is formed of a plastically deformable.

19. Molded plastic article as claimed in claim 13, wherein the injected or foamed molded section is a sliding headliner for a motor vehicle roof.

20. Molded plastic article as claimed in claim 19, wherein the insert part comprises a sliding element for the sliding head liner.

21. Process for producing a molded plastic article formed of a molded section and at least one insert part in a molding tool which has an openable tool unit in which a mold cavity is formed, comprising the steps of:
providing the at least one insert part with a deformable molded body such that the insert part extends through the molded body,
locating the molded body together with the insert part extending therethrough in the region of an edge of the mold cavity,
closing the tool unit in a manner causing the molded body to undergo deformation sealing the mold cavity with the molded body in a region of emergence of the insert part from the mold cavity, and
forming the molded section by filling the mold cavity with an injected or foamed material in a manner connecting the material to the at least one insert part and the deformed molded body.

22. Process as claimed in claim 21, wherein the molded body is molded onto the insert part prior to said locating step.

23. Process as claimed in claim 21, wherein the tool unit is provided with a pinch edge in the region of the molded body, the pinch edge engaging the molded body when the tool unit is closed.

24. Molded plastic article as claimed in claim 21, wherein the molded body is located in the region of the plane of separation of the molding tool during said locating step for being engaged by the molding tool during said closing step.
